(19) United States
(12) Patent Application Publication
(10) Pub. No.: US 2023/0367428 A1
(43) Pub. Date: Nov. 16, 2023

(54) METHOD FOR DETECTING A MOVEMENT BY AN INPUT ITEM RELATIVE TO A DISPLAY APPARATUS BY WAY OF OPTICAL FEATURES, RECORDING APPARATUS WITH COMPUTING UNIT, DISPLAY APPARATUS AND MOTOR VEHICLE

(71) Applicant: AUDI AG, Ingolstadt (DE)

(72) Inventor: Markus KLUG, Ingolstadt (DE)

(73) Assignee: AUDI AG, Ingolstadt (DE)

(21) Appl. No.: 18/043,739

(22) PCT Filed: Aug. 11, 2021
(86) PCT No.: PCT/EP2021/072344

§ 371 Date: Mar. 2, 2023

(30) Foreign Application Priority Data
Sep. 2, 2020 (DE) 10 2020 122 969.0

(51) Int. Cl. G06F 3/042; G06V 40/20

(52) U.S. Cl. CPC G06F 3/0425; G06V 40/28; G06F 3/0414

(57) ABSTRACT

A method controls a display function of a display apparatus by any input object by a touchscreen. A camera of a recording apparatus creates an image sequence of a user-facing screen surface of the display apparatus. In images of the image sequence, a computing unit of the recording apparatus tracks when the input object is tilted, inclined or rolled away relative to the screen surface. The computing unit searches for a pattern comprising a depth profile in a surface structure of the input object and evaluates a change in the image values relating to a contrast, the definition of the pattern, or, additionally or alternatively, a visible portion of the surface structure in the image sequence. From the change in the pattern or in the portion of the surface structure visible to the camera, the computing unit determines a motion vector of the input object to control the display function.

### CROSS REFERENCE TO RELATED APPLICATIONS

This application is a U.S. national stage of International Application No. PCT/EP2021/072344, filed on Aug. 11, 2021. The International Application claims the priority benefit of German Application No. 10 2020 122 969.0 filed on Sep. 2, 2020, the disclosures of each of which are herein incorporated by reference in their entirety.

### BACKGROUND

Aspects of the invention relate to a method for controlling a display function of a display apparatus.

Some electronics manufacturers offer styluses for electronic appliances like tablets and displays, with which the user can draw or write on his appliance. In particular, some manufacturers are concerned with the accurate capture of position, pose and movement of the stylus as an input device with respect to the electronic appliance already for a long time. Thereby, virtual brush tips can be simulated as a 3D object, whereby a realistic behavior of the drawing instrument in drawing is allowed. Therein, the systems are based on inductive methods or other hardware solutions (accelerometer, gyro sensor, optical and magnetic) and require special hardware.

In the inductive method, a magnetic field is generated across a screen or drawing surface and an input device including at least three coils is moved in the magnetic field. Based on the orientation of the respective coils in the magnetic field above the screen or drawing surface, an orientation of the input device can be recognized. For example, with the finger as the input device, an extended capture of roll, tilting and inclination axis and thereby of an orientation of the finger with respect to the screen or drawing surface is not possible at present. Therein, a movement around a roll, tilting and inclination axis corresponds to a movement and/or a rotation around one of the respective axes of a three-dimensional coordinate system, the origin of which is situated on the screen surface.

Various input methods by a special input device or a finger are known from the following publications.

From DE 11 2013 003 647 T5, a display apparatus with a computing unit for capturing gesture and touch inputs via a touchscreen by means of force sampling is known. Therein, the display apparatus comprises a touchscreen with a force sensor, which is configured to measure a force and a force centroid on a screen surface. When the force centroid is within a boundary, for example within the screen surface, a force input and a touch gesture can be recognized upon exceeding a threshold value by the input force and a function can be controlled by a computing unit.

From DE 10 2011 084 809 A1, a user interface and a method for computer-assisted control of the user interface are known. Therein, by means of a token, which has the shape of a puck and has a barcode imprinted on the bottom side, any parameter values are adjusted via a user interface by means of a rotational movement of the token. The said token can be applied on a surface of a touchscreen, wherein a recording apparatus captures the bottom side of the token with the barcode on the side of the screen surface facing away from the user and therein ascertains a position and orientation of the token on the touchscreen. By means of a rotational movement of the token, a parameter can be adjusted by a user. It is disadvantageous in the known methods for controlling that a user input is restricted to a special input medium, namely the token.

From DE 10 2017 004 860 A1, a system for handwriting recognition in a vehicle via an input surface of a touchpad by means of a camera and a computing unit is known. By means of the camera, a hand or a hand movement of a user directed to the touch-sensitive input element is captured. Therein, the computing unit determines the input character by means of a shape comparison between a reference character stored in the database and the character rotationally transformed captured by the camera unit. It is disadvantageous in the known method that only an orientation in a tilting direction of the hand and with respect to the touchpad is captured and not an object orientation in a roll direction or in an inclination direction, therefore in all three dimensions.

It is disadvantageous in the solutions in the above-mentioned publications that three-dimensional touch gestures are not captured.

### SUMMARY

An aspect of the invention is to provide a movement including a rotation and/or a translation of an input item with respect to a screen surface in a motor vehicle.

By an aspect of the invention, a method for controlling a display function of a display apparatus includes:
a) Capturing images of an image sequence of a surface structure of an input object in an input region on a user-facing side of a screen surface of the display apparatus by a recording apparatus, wherein the input region is optically captured through the screen surface from the direction of a side of the screen surface facing away from the user;
b) recognizing that a surface structure is in a focus of the recording apparatus on the user-facing side of the screen surface, by the recording apparatus;
c) searching the first image of the image sequence for a pattern in the surface structure of the input object by a computing unit (for example, a computer);
d) when a pattern of the surface structure of the input object is recognized in the respective images of the image sequence, determining an orientation and/or a position of the pattern of the surface structure of the input object in the input region by the computing unit;
e) determining a motion vector of the pattern between the respective orientation and position of the surface structure between an image and an image of the image sequence following the image (4) by the computing unit;
f) controlling the display function of the display apparatus by the motion vector.

An aspect of the invention tracks when the input object is tilted and/or inclined and/or rolled away in that a change of the pattern in the images of the image sequence arising upon tilting and/or inclination and/or rolling away is mapped as tilting and/or rolling and/or inclination of the input object in the motion vector by the computing unit (for example, a computer or processor).

In other words, the surface structure can be the portion of the input object visible to the recording apparatus. Therein, the surface structure can include a pattern. When the input object is for example a finger, the surface structure of the portion of the finger visible to the recording apparatus with respect to the screen surface can therefore be a finger outline or the skin surface of the portion of the finger facing the screen surface. Then, the pattern can be a picture of a depth profile of the skin surface of the finger such as for example the friction ridges of the fingertip, which can leave a fingerprint. In a rolling, tilting and/or inclination movement of the finger on the screen surface, the recording apparatus can recognize a change of the visible picture of the pattern, therefore of the fingerprint. From the change of the fingerprint of the friction ridges visible to the recording apparatus and/or from a change of the portion of the surface structure visible to the recording apparatus, the computing unit of the recording apparatus can determine a motion vector of the finger for controlling a display function.

The respective tilting, inclination or rolling movement can include a rotational movement around a coordinate axis of a three-dimensional cartesian coordinate system, which can have its origin on the screen surface. Therein, the x-axis can, for example, be in a longitudinal direction on the screen surface of the display apparatus, the y-axis can be in a transverse direction to the screen surface and the z-axis of the coordinate system can be perpendicular on the screen surface pointing to the user-facing side. An inclination movement can, for example, be a rotation of the input object around the y-axis, a tilting movement can be a rotation of the input object around the x-axis and a rolling movement can be a rotation around the z-axis. In performing the respective movement, a motion vector can be determined by the computing unit according to the method, and the respective tilting, inclination or rolling movement of the input object can be inferred based on the motion vector.

The respective tilting, inclination or rolling movement can also include a combination with a further tilting, inclination or rolling movement or a combination with a translational movement of the input object on the screen surface.

The display apparatus can include a screen with a screen surface, via which a touch input can be performed by the input object. Therein, the screen surface of the touchscreen of the display apparatus can comprise a user-facing side and a side facing away from the user. On the user-facing side of the screen surface, a user, who performs a user input on the touchscreen for example by a finger as the input object, can be located. The display apparatus can be a touchscreen of a mobile appliance, such as, for example, a smartphone, a tablet or a computer, or a touchscreen of a motor vehicle. Therein, the input object can, for example, be any item such as, for example, a finger of a hand of the user or an eraser. A recording apparatus can be located on the side of the screen surface of the display apparatus facing away from the user and optically capture the user input by the input object on the touchscreen. Therein, the recording apparatus can be attached in or behind the display of the touchscreen and, for example, be a holographic-optical element, a display camera or a camera behind a translucent display.

Now, a sequence of images of the side of the screen surface facing away from the user is recorded by the recording apparatus. Therein, the camera apparatus (or camera) of the recording apparatus can have a focus, which can be adjusted on the user-facing side of the screen surface or in a region in the vicinity of the user-facing side of the screen surface. An input object with a surface structure, for example a finger with a depth profile, in particular a friction ridge pattern for a fingerprint, can be guided into the focus of the recording apparatus in the vicinity of the screen surface on the user-facing side for performing a user input. The surface structure can be the portion of any input object visible to the recording apparatus. Therein, the surface structure can include a pattern, wherein the pattern can also comprise a depth profile such as, for example, the depth profile of the fingerprint.

Therein, the recording apparatus is configured to recognize the surface structure of the input object, therefore the surface structure of, for example, the finger. Recognizing the pattern in the surface structure of the finger can be performed by the computing unit in an initial image as a first image of the image sequence, from which the input object is located in the focus of the recording apparatus. An initial image as a first image of the image sequence, in which a surface structure of the input object can become visible to the recording apparatus, can be searched for a pattern in the surface structure by the computing unit. For example, this can be effected by an interpolation or a vectorization of the respective image in the image sequence. The initial image can be a first image, which the recording apparatus records from the surface structure, and can be used as a reference image for the determination of a change of the pattern in a rolling and/or inclination and/or tilting movement of the input object. Therein, the respective rolling, tilting or inclination movement can be combined with a translational movement of the input object in a plane parallel to the user-facing screen surface. From the respective change of the pattern in an image of the image sequence compared to the reference image and/or to a previous image in the image sequence, the computing unit can calculate a motion vector corresponding to the respective movement.

For calculating the motion vector, the computing unit can also use image variables, such as for example contrast, image definition or scaling, changing compared to the reference image and/or to a previous image in the image sequence.

Therein, for the surface structure, which is opposing the user-facing side of the screen surface, a depth profile of the surface structure can also be visible to the camera apparatus (or camera). The camera apparatus of the recording apparatus can be configured to recognize the depth profile of the surface structure, such as for example the fingerprint of a finger or a rough surface of an input stylus.

Therein, the pattern can comprise prominent points or a connection of the prominent points of the surface structure. For example, the pattern can include a number of prominent ridges of the fingerprint of the respective finger. For example, when a finger is longitudinally laid on the screen surface, the recognized pattern can, for example, be the fingerprint and the surface structure can be the portion of the body of the finger visible for the recording apparatus. When a pattern in the surface structure of the one object, for example the prominent ridges, is captured, an orientation and/or a position of the pattern and thereby of the input object can be recognized in the input region of the touchscreen by the computing unit.

For example, when a stored pattern to the recognized pattern is present in a storage of the computing unit, thus, a motion vector can be determined by the computing unit based on the difference between the recognized pattern and the stored pattern and thereby an orientation of the input object in the input region of the touchscreen can also be determined. Therein, the stored pattern can be a pattern stored before the input or a pattern learned in an initial image of the image sequence. Based on the pattern, a position of the input object in the input region can also be captured. Independently of the pattern, a position of the input object in the input region can also be determined. The recording apparatus can be configured to capture an optically captured surface structure of any non-reflecting or non-transparent input object. For example, the pattern can be a perimeter or an outline of the portion of the surface structure of the input object, which is visible to the recording apparatus.

From the change of the orientation and/or position of the pattern between at least a first image of the image sequence after the initial image and a second image of the image sequence following the first image, the computing unit can determine a motion vector of the input object. By the motion vector, the computing unit can control a display function of the display apparatus.

Alternatively, a rotation of the pattern around a normal axis of the input object with respect to the screen surface and thereby a rotation of the input object can be determined from the orientation of the pattern for controlling the display function.

Hereby, the advantage arises that any item can be used as the input object for an input via a touchscreen when the item has a corresponding opacity and a non-reflecting surface structure. For example, the input object can be a finger or a stylus. Thereto, a 3D input with all degrees of freedom (rotation, translation, optionally pressure and height) and thereby new operating approaches are allowed. Furthermore, a further input device does not have to be carried along and a possible loss of the input device is irrelevant since a finger can for example also be used as the input device and thereby space can be saved.

Examples, by which additional advantages arise, also belong to aspects of the invention.

An example provides that the pattern is learned in one or more initial images of the image sequence. In other words, when the surface structure of the input object is unknown to the computing unit, thus, the computing unit can perform pattern recognition by image processing in the initial image of the surface structure captured by the recording apparatus. For example, this can be effected by an initial image or multiple initial images when a pattern could not yet be successfully recognized by the computing unit in the first image alone. As the reference image for determining the changing image variables, such as for example contrast, image definition or the scaling, the first image can be taken, in which a pattern in the surface structure was recognized by the computing unit. Hereby, the advantage arises that any objects, which can be optically captured, can be used as input devices.

The computing unit can be configured to recognize a pattern from any surface structure and to determine a motion vector of the input device based on the change of the pattern. Thus, an example provides that a determination of the motion vector includes evaluation of a change of an image definition and/or a contrast and/or a scaling of the pattern and/or of a portion of the surface structure of the input object visible to the recording apparatus in the images of the image sequence. In other words, the computing unit can consider a change of the pattern in the respective images of the image sequence in the calculation of the motion vector. Therein, the image variables can be a change of the contrast and/or a change of the image definition and/or of the scaling of the pattern in an image of the image sequence compared to the previous image in the image sequence and/or to the reference image.

Additionally or alternatively to the pattern, the computing unit can ascertain a movement from a change of the portion of the surface structure visible to the recording apparatus for the respective image of the image sequence compared to the previous image in the image sequence and/or to the reference image.

For example, when the finger resting on the screen surface is erected such that the finger touches the screen surface only with the fingertip, thus, a change of the contrast and/or of the image definition of the portion of the surface structure of the finger visible to the recording apparatus compared to the reference image can arise at the location, at which the body of the finger rested on the screen surface before the erection of the finger. For example, the capturing apparatus can recognize a contrast change in erecting the finger and determine a motion vector of the finger from it additionally or alternatively to the corresponding change of the pattern, such as for example a fingerprint. For example, when a finger lying on the screen surface is erected such that the finger touches the screen surface only with the fingertip after erection, the computing unit can calculate the motion vector of the finger by of the change of the image values of the fingerprint recognized by the computing unit as the pattern in the respective images and/or in the change of the visible portion of the surface structure during the movement of the erection. The change of the pattern and/or of the portion of the surface structure visible to the recording apparatus arising in erecting the finger can be determined by the computing unit by a change of the image variables of the respective images of the visible portion of the surface structure including the contrast and/or the image definition and/or the scaling. From the change of the respective image variable or a combination of the image variables of the respective images of the image sequence, the computing unit can determine a motion vector of the input object.

Hereby, the advantage arises that a movement in the direction of the degrees of freedom with respect to the rotation around the axes of the respective three-dimensional coordinate system can be determined by the computing unit. By the use of the change of the image values in combination, a redundant determination of the respective 3D input by the input object can also be effected.

After the successful recognition of the pattern by the computing unit of the recording apparatus, a motion vector can be determined by the computing unit. An example now provides that the control of the display function of the display apparatus is only effected after recognizing a stored, authorized pattern of the surface structure of the input object in an image from the image sequence. In other words, only after recognizing a certain, stored and authorized pattern by the computing unit, the control of the display function can be initiated. For example, after recognizing a fingerprint, which was previously stored in a storage of the computing unit as an authorizing fingerprint, the control of the display function by the computing unit can be authorized. Therefore, only a user with his specific fingerprint can for example control a display function of the display apparatus. Hereby, the advantage arises that a coding of the input by a fingerprint or a specific feature of a surface structure can be effected. Hereby, the advantage also arises that certain display functions can be initiated by a certain, recognized pattern.

Now, an example provides that at least one display function is respectively associated with at least one pattern of the input object. In other words, a certain display function can be associated with a certain, previously stored pattern. For example, a function of painting or drawing can be initiated by the fingerprint of the index finger and upon recognition of the fingerprint of the little finger, a function of a virtual erasing. Hereby, the advantage arises that a coding of the display function can be performed according to a pattern.

Likewise, the 3D input by the input object can be extended by a further parameter. Thus, an example provides that the capture of the respective image of the image sequence is effected in combination with a pressure sensor on the screen surface, wherein the pressure sensor measures a pressure of an input by the input object and the capture of the respective image of the image sequence is initiated upon exceeding a threshold value by the pressure or at least one announcement function is associated with a value of the measured pressure. In other words, the touchscreen of the display apparatus can include a pressure sensor, which can measure a pressure and/or a pressure centroid. When an input is performed by the input object on the screen surface, thus, the input can be associated with a pressure. For example, upon exceeding of the pressure of the input measured by the pressure sensor, a display function can be initiated. Hereby, the advantage arises that an erroneous input, which could for example be initiated by a fly on the screen surface, can for example be avoided. Likewise, a display function can be correlated with a value of the pressure and associated with it. For example, upon exceeding a first threshold value by the pressure of the input, drawing a thin line can be initiated, and upon exceeding a second threshold value, which is greater than the first threshold value, by the pressure, drawing a bold line different from the thin line can be effected. Hereby, the advantage arises that an extended spectrum of display functions can be associated by the combination of the 3D input with a pressure.

Likewise, a display function can be associated with an optical marker. Thus, an example provides that the pattern of the input object includes at least one optical marker including at least one pattern for respectively controlling a display function. In other words, an input stylus can for example be used as the input object for operating a tablet computer. Therein, the stylus can include a marker, which can for example be designed as a QR code. When a specific QR code is recognized by the computing unit of the recording apparatus on the screen surface, thus, an erasing function can for example be initiated by the QR code. Likewise, an erasing function can be associated with a first QR code as the display function, drawing thin lines can be associated with a second QR code, and drawing bold lines can be associated with a third QR code. Likewise, a change of a vehicle-specific parameter can be associated by a QR code. For example, a change of an air conditioner temperature can be associated with a certain QR code.

Therein, the optical markers can also be used as anatomic features of a body item, such as for example a fingerprint of a specific finger like that of a middle finger. Thus, an air conditioner temperature can for example be adjusted only by the fingerprint of the middle finger and a navigation function can be operated by the fingerprint of an index finger. Hereby, the advantage arises that a display function can also be extended by certain optical markers of the input object.

An example provides a computing unit, which is configured to perform the above described method for recognizing a movement of an input item with respect to a display apparatus.

An example provides a recording apparatus with a computing unit, which is configured to perform the above described method.

Likewise, a further example provides a display apparatus with the said recording apparatus and the computing unit. The display apparatus can be a touchscreen of a mobile appliance such as for example a smartphone, a tablet or a computer, or a touchscreen of a motor vehicle.

An example provides a motor vehicle with the computing unit or the recording apparatus and the computing unit.

The invention also includes the combinations of the features of the described examples.

The control device for the motor vehicle also belongs to an aspect of the invention. The control device can comprise a data processing device or a processor device, which is configured to perform an example of the method according to an aspect of the invention. Hereto, the processor device can comprise at least one microprocessor and/or at least one microcontroller and/or at least one FPGA (Field Programmable Gate Array) and/or at least one DSP (Digital Signal Processor). Furthermore, the processor device can comprise a program code including instructions, which is configured, upon execution by the processor device, to perform the example of the method according to an aspect of the invention. The program code can be stored in a data storage of the processor device.

Developments of the method according to the invention, which comprise features, as they have already been described in context of the developments of the motor vehicle according to the invention, also belong to the invention. For this reason, the corresponding developments of the method according to the invention are not again described here.

The motor vehicle according to the invention is preferably configured as a car, in particular as a passenger car or truck, or as a passenger bus or motorcycle.

The invention also includes the combinations of the features of the described embodiments.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 a schematic representation of a longitudinal section of the display apparatus,

FIG. 2 a schematic representation of the method for controlling the display function of the display apparatus,

FIG. 3 a perspective of the recording apparatus to the input object from a side of the screen surface facing away from the user, and

FIG. 4 an association of a display function with a gesticulation.

### DETAILED DESCRIPTION

Reference will now be made in detail to the embodiments, examples of which are illustrated in the accompanying drawings, wherein like reference numerals refer to like elements throughout.

The embodiment explained in the following is an example of the invention. In the example, the described components of the example each represent individual features of the invention to be considered independently of each other, which also each develop the invention independently of each other and thereby are also to be regarded as a constituent of the invention in individual manner or in a combination different from that shown. Furthermore, the described example can also be supplemented by further ones of the already described features of aspects of the invention.

In the figures, identical reference characters each denote functionally identical elements.

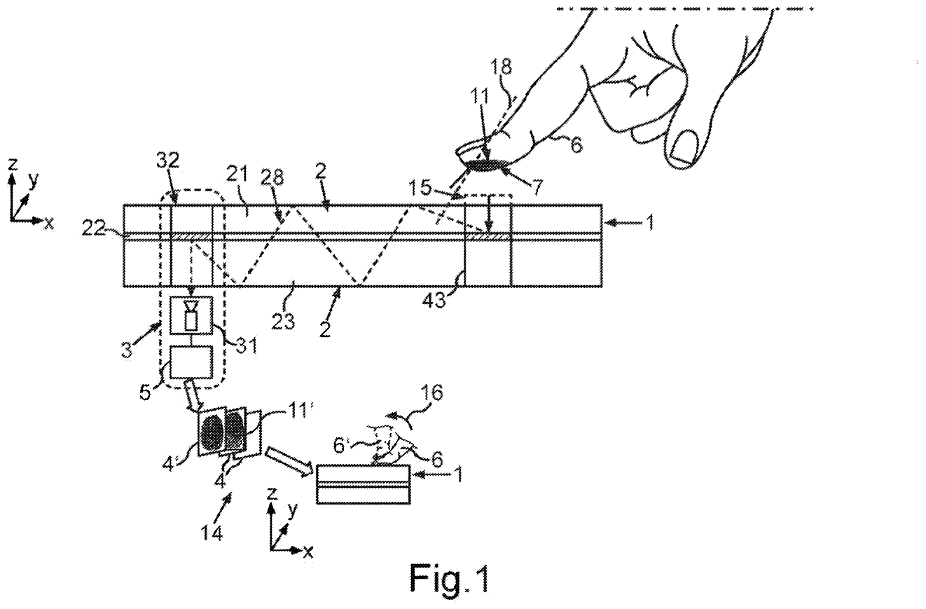

FIG. 1 shows a side view of the display apparatus 1. Therein, the display apparatus 1 comprises a touchscreen with a user-facing screen surface 2 and a screen surface 2′ facing away from the user. Therein, the display apparatus 1 can for example be a touchscreen. The display apparatus 1 comprises two optical carrier media 21 and 23, wherein the optical carrier medium 21 is the user-side carrier medium and the carrier medium 23 is the carrier medium facing away from the user. A holographic-optical layer 22 is located between the carrier media 21 and 23.

The display apparatus 1 further includes a capturing region 13 and a recording apparatus 3 including a recording region 32, a camera apparatus 31 and a computing unit 5. For example, the capturing region 13 can be a screen surface, on which touch inputs can be performed by the user. Therein, the recording apparatus is configured such that the camera apparatus of the recording apparatus records each one image of the user-facing side of the screen surface 2 in a previously adjusted, temporal distance. Therein, an image 4 of the image sequence 14 is respectively processed in the computing unit. Therein, the image sequence 14 is composed of an initial image 4′ as a first image of the image sequence and at least one image 4 following the initial image.

The recording apparatus 3 records an image of the surface structure 7 of the input object 6, which is in the input region 13 of the recording apparatus 3 in the focus 15 above or on the screen surface 2. Here, the input object 6 is the finger of a user. Therein, the finger of the user comprises a surface structure 7, such as for example the side of the input object 6 facing the screen surface 2, and a fingerprint as the pattern 11 in the surface structure 7.

For orientation, a cartesian coordinate system is next to the recording apparatus 3, wherein the x-axis is in the longitudinal direction of the display apparatus 1, the y-axis is in transverse direction of the display apparatus 1 and the z-axis is vertical to the display apparatus 1. Analogously thereto, a longitudinal axis 17 and a transverse axis 18 for describing the movement of the input object 6 are drawn in the input object 6. Therein, the longitudinal axis 17 moves parallel to the x-axis of the cartesian coordinate system and the transverse axis 18 moves parallel to the y-axis.

The recording apparatus 3 is arranged with respect to the display apparatus 1 such that it records an image of the user-facing side of the screen surface 2 by the holographic-optical layer from the perspective of a camera apparatus arranged on the side of the screen surface 2′ facing away from the user. Therein, this is illustrated as a holographic-optical capturing apparatus in FIG. 1. An image of the surface structure 7 of the input object 6 is shown over the capturing region 13 and the light 28 is refracted by of the image of the input object by the holographic-optical layer 22 by a respective grid structure in the capturing region 13 and in the recording region 32 of the recording apparatus 3 and respectively guided by internal reflection through the carrier medium 21 and 23 to the camera apparatus 31 of the recording apparatus 3. Therein, the holographic-optical layer refracts the light 28 and guides it out of the carrier medium 23 into the camera apparatus 31 of the recording apparatus 3.

Now, the camera apparatus 31 is configured to continuously record each one image 4 of an image sequence 14 of the capturing region 13 in at least a certain temporal distance. Therein, the camera apparatus 31 views the input region 13 via the carrier media 21 and 23 analogously to the manner of a periscope, by which one can see the user-facing side of the screen surface from below. Therein, the field of view in the camera apparatus 31 is the entire capturing region 13, which can for example be a screen surface 2 of an operating region of the display apparatus 1. Additionally or alternatively, the capturing region 13 can also be a drawing surface such as for example a touchpad.

Now, the camera apparatus 31 is configured to record each one image of an image sequence 14 in at least a predetermined temporal distance. Therein, the respective images 4′ and 4 of the image sequence 14 of the camera apparatus are evaluated by the computing unit 5 and an initial image 4′ and/or an image 4 are stored. When the computing unit 5 of the recording apparatus 3 recognizes a surface structure in the region of the focus 15 in an initial image 4′ of the camera apparatus 31, thus, the first image 4, in which the surface structure 7 of the input object 6 is recognized, is the initial image 4′ of the image sequence 14. Therein, the recognition of the surface structure 7 by the camera apparatus 31 is effected by first application of the input object 6, thus of the finger, onto the user-facing screen surface 2 in the input region 13. The computing unit 5 searches the initial image 4′ for a pattern 11 in the surface structure 7.

In the illustrated case, the fingerprint of the finger can be recognized as the pattern 11 by the computing unit 5 and the initial image 4′ with the recognized fingerprint can be stored as a reference image. Based on the pattern 11 in the initial image 4′, an orientation and a position of the input object 6 in the input region 13 can now be effected, for example when the finger is positioned on the bottom right or on the top left in the input region. Now, in the following images 4 of the image sequence 14, a change of the pattern 11 is determined by the computing unit 5 with respect to the initial image 4′ and/or with respect to an image preceding an image 4 in the image sequence 14. From the difference of the orientation and position in a movement of the input object 6 in the respective images 4 of the image sequence 14, the computing unit 5 can determine a motion vector of the input object 6. In the illustrated case, the motion vector 16 can for example be a tilting movement, which corresponds to a rotation of the input object around the y-axis, therefore around its transverse axis 18. From the perspective of the camera apparatus 31, which is on the side of the screen surface 2′ facing away from the user, disappearance of the lower half 11′ of the pattern 11 in the image 4 compared to the initial image 4′ is perceived, wherefrom the computing unit 5 can determine that a tilting movement of the input object 6 analogously to the motion vector 16 is present. Therein, the disappearance of the lower half 11′ of the pattern 11 can be recorded distributed over multiple images 4 of the image sequence 14. From the change of the pattern 11 in the respective images 4 of the image sequence 14, the computing unit 5 can determine a motion vector 16 of the input object 6.

Additionally or alternatively, the computing unit 5 can determine a motion vector 16 of the input object 6 by a change of the contrast and/or the image definition of the portion of the surface structure of the finger visible to the recording apparatus in the images 4 compared to the reference image and/or to an image 4 preceding the image 4 in the image sequence. In the image 4, the recording apparatus 3 can recognize a contrast change in the lower half 11′ of the pattern 11 in the image 4 compared to the initial image 4′ in erecting the finger and determine the motion vector 16 of the finger therefrom.

Additionally or alternatively to the contrast change of the lower half 11′ of the pattern 11 in the image 4, the computing unit 5 can use a change of the image definition and/or the scaling of the pattern 11 in the image 4 compared to the initial image 4′ and/or to an image 4 preceding the image 4 in the image sequence for determining the motion vector 16. From the change of the respective image variable or a combination of the image variables of the respective images 4 of the image sequence 14, the computing unit 5 can determine a motion vector 16 of the input object 6.

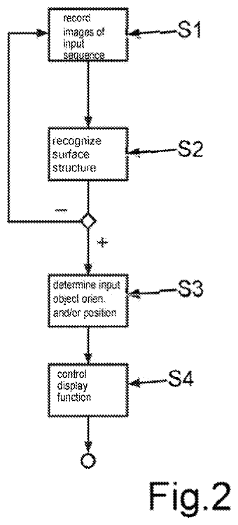

In FIG. 2, the method for controlling the display function is illustrated step by step. In a first step S1, images 4′ and 4 of an image sequence 14 are recorded by the recording apparatus 3 of the user-facing side of the screen surface 2 of the display apparatus 1.

Now, in a second step S2, a surface structure 7 of the input object 6 in a focus 15 of the recording apparatus 3 on the user-facing side of the screen surface 2 is recognized. For example, this can be used as a trigger for recognizing a user input by the computing unit 5 by recognizing an outline of the surface structure 7 or a threshold value for a contrast decrease of the portion of the surface structure 7 visible to the recording apparatus 3 in an image 4 of the image sequence 14. Now, when the surface structure 7 of the input object 6 is recognized, thus, the computing unit 5 searches for a pattern 11 in the surface structure 7 in the first image 4 of the image sequence 14, the so-called initial image 4′. When a pattern 11 in the surface structure 7 is not recognized in the initial image 4′ by the computing unit 5, the search for the pattern 11 can be continued in the next image 4 up to a suitable maximum number of images 4. The initial image 4′ is stored as a reference image by the computing unit 5.

If the computing unit 5 does not recognize a pattern 11 in the surface structure 7 or a suitable surface structure 7, for example when the contrast change of the visible portion of the surface structure 7 falls below a threshold value, in the second step S2, thus, the computing unit 5 returns to step S1. However, when the computing unit 5 recognizes a pattern 11 in the surface structure 7 or the visible portion of the surface structure 7 exceeds a threshold value for a contrast change, thus, the method proceeds in the third step S3.

For the pattern 11, an orientation 8 and/or a position 9 of the input object 6 in the input region 13 is now determined by the computing unit 5 in step S3. For example, this can first be a certain position in the input region 13 on the user-facing screen surface 2. Within the scope of step S3, further images 4 of the surface structure 7 are now recorded by the recording apparatus 3, which are compared to the initial image 4′ and/or to an image 4 preceding the image 4 in the image sequence 14 by the computing unit 5. From the difference of the pattern 11 and/or the difference of the image values such as for example contrast, image definition and/or scaling of the pattern and/or of the visible portion of the surface structure 7 of the respective images 4 and 4′, a motion vector 16 of the input object is determined by the computing unit 5.

From the calculated motion vector 16, a display function of the display apparatus 1 is now controlled in a fourth step S4. For example, when the motion vector 16 represents a tilting movement, thus when the finger is for example put onto the screen surface of the display apparatus 1 with the fingertip and therein the hand now tilts against the display surface, an adjustment for drawing can be changed, which for example changes the drawing from an initially thin line to a bold line.

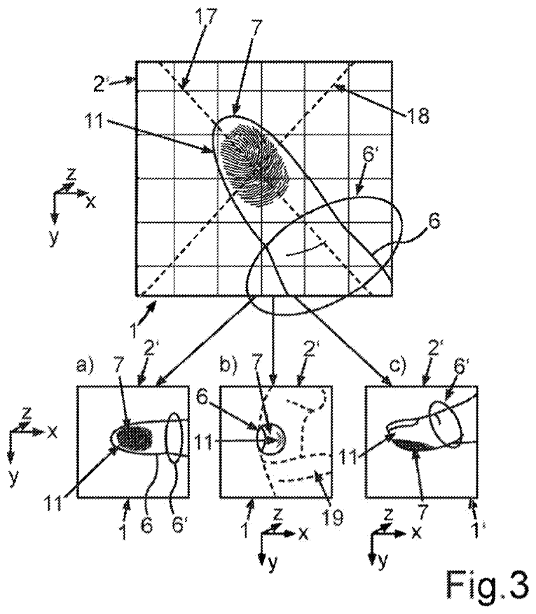

Now, FIG. 3 shows a view of the screen surface 2 from the perspective of the camera apparatus 31 of the recording apparatus 3, wherein the camera apparatus 31 views the user-facing side of the screen surface 2 from the view of the side of the screen surface 2′ facing away from the user. Now, the screen surface 2, the input object 6 with the surface structure 7 and the pattern 11 are visible. For orientation, the cartesian coordinate system correspondingly rotated in the perspective is also further illustrated. The camera apparatus 31 views from below through a display of the display apparatus 1 to the finger as the input object 6. Further, the longitudinal axis 17 and the transverse axis 18 of the input object 6 are illustrated.

Now, it is to be shown how a motion vector 16 of the input object 6 can be determined by the computing unit 5 from a change of the pattern 11 of the surface structure 7. From the initial image 4′, the camera apparatus 31 of the recording apparatus 3 records an initial image 4′ of the surface structure 7 and searches it for a pattern 11. Therein, a value of an image definition, of a scaling, of a contrast as well as of the portion of the surface structure 7 visible to the recording apparatus is stored to the initial image 4′ as the reference image. For example, this can be the outline of the finger 6 in the image a). Therein, the image values are captured by the camera apparatus 31 for each pixel of the initial image 4′.

For the respective movements of the finger, three exemplary possibilities are now shown:

In the image a), a rolling movement of the input object 6 is performed. Therein, the finger rotates around the z-axis. Now, when the input object 6 is rotated around the z-axis, thus, a change of the contrast and of the image definition does not occur since the finger as the input object 6 is in the same focus of the camera apparatus 13, thus does not depart from a plane parallel to the screen surface 2. The scaling of the pattern 11 and of the visible portion 6′ of the surface structure 7, here the outline of the finger, either does not change. Therein, the computing unit 5 can recognize when the input object 6 remains in the same plane with respect to the screen surface. From the change of the orientation of the pattern 11 in addition to an unchanged contrast, an unchanged image definition of the pattern 11 and/or additionally of the visible portion 6′ of the surface structure 7, the computing unit 5 can recognize a rotation of the input object 6 in an image 4 compared to the initial image 4′.

In the image a), the texture of the input object 6 is clockwise rotated. A scaling or contrast change does not occur. The fingertip rotates around its vertical axis z.

In the image b), a tilting movement of the input object 6, therefore a rotation around the y-axis, is now to be presented. For the camera apparatus 31, the surface structure 7 is now recognizable as a fingertip, which has the pattern 11 as a fingerprint. Therein, the hand 19 for orientation can actually be visible to the camera apparatus 31 or else not. Now, the camera apparatus 31 records the view illustrated in the image b) as an image 4 and can calculate a difference to the initial image 4′. Therein, the computing unit 5 can recognize a change of the pattern 11 and of the portion of the surface structure 7 visible to the camera apparatus 31. By a change of the contrast of the visible portion of the surface structure 7′, the computing unit 5 can recognize that the said portion of the surface structure 7′ departs from a plane parallel to the screen surface 2. Therein, a contrast change in the said regions occurs, wherein the pattern 11 is linearly transformed. From the corresponding changes of the pattern 11 and of the contrast as well as the image definition of the pattern 11 and of the visible portion of the surface structure 7′, the computing unit 5 can determine a motion vector 16, which indicates a tilting movement.

In the image b), the texture is linearly transformed, barrel-shaped distorted and there is a contrast decrease at the edge. The fingertip rotates around its transverse axis 18.

In the image c), an inclination movement of the input object 6, therefore a rotation of the input object 6 around the x-axis, is now illustrated. Therein, as a difference to the initial image 4′ from image a), a contrast change of the pattern 11, but no change of the visible portion 6′ of the surface structure 7, now also occurs. From the respective direction of the change of the contrast of the pattern 11 and additionally of the visible portion 6′ of the surface structure 7, the computing unit 5 can determine a motion vector 16 for an inclination movement. Therein, the surface structure 7 is linearly transformed, but offset by 90° with respect to image b). The fingertip rotates around its longitudinal axis 17.

Not outlined, but translational movements (texture remains the same, but moves in a direction) as well as movement towards and away from the display (contrast decreases/increases) as well as touch of the display or pressure on the display (via touch, 3D touch and change of the texture itself) are possible.

From the motion vector 16, the computing unit 5 can now infer a rotational movement of the input object 6. According to the position of the input object 6 on the screen surface 2, a position of the input object 6 to the input region 13 can also be determined. From the change of the position, translational movements can be determined. Thereby, it is also possible to combine the rotational and the translational movement with each other, for example when the finger as the input object 6 is rolled away over the screen surface analogous to a roller, which transversely rolls over the display. Therein, the change of the visible portion 6′ of the surface structure 7, of the image definition and of the contrast is effected together with a positional change of the visible portion 6′ of the surface structure 7.

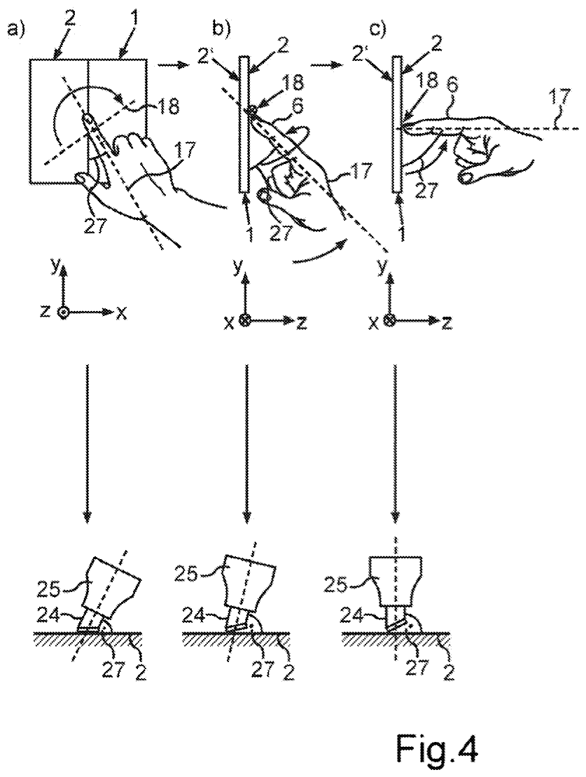

In FIG. 4, forms of application for controlling a display function based on the determined motion vector 16 are now illustrated. Hereto, in FIG. 4, a sequence of movements is shown in the image a), b) and c). In the sequence in the image a), a rotational movement is performed on the screen surface 2 by a user with the finger as the input object 6. Therefore, the finger rotates around its longitudinal axis 17 or transverse axis. Hereto, in the image a) on the bottom, drawing with a bold line analogously to a marker pen 25 with a tip 24 can be represented as a display function. When the finger is now laid on the screen surface 2 at a low angle 27, for example below 45°, analogously to the part a) in the image a), thus, drawing with a bold line analogously to holding a marker pen at the same angle 27 can be executed as a display function. Therein, rotating the finger as the input object 6 around the longitudinal axis 17 can also be represented as a rotation of the virtual marker pen 25 at the same angle 27 with respect to the screen surface 2. Hereto, the tip rotates analogously to the angle 27. When the angle 27 is further increased over the image b) such that the input object 6 is perpendicular to the screen surface 2 at the angle 27 as finally in image c), thus, the display function can now provide drawing a thin line, analogously to viewing the tip 24 of the virtual marker pen 25 with respect to the screen surface 2. When the finger as the input object 6 is rotated with respect to the longitudinal axis 17, this can correspond to a rotation of the marker pen 25 with respect to the screen surface 2.

Via a recording apparatus behind the display (holocam, pixel in the display, camera behind transparent display) with or without touch functionality, the space directly above the screen is recorded. Herein, the focus should be as close to the screen surface as possible and allow recognizing relevant texture and also higher contrast.

The successively recorded images are searched for recognizable image contents (textures, fingerprints, markers, image definition). These image contents are now analyzed image by image, wherein the movement of the pixels as well as the distortion as well as the contrast can be used to estimate the type and direction of movement.

Not outlined, but translational movements (texture remains the same, but moves in a direction), as well as movements towards and away from the display (contrast decreases/increases) as well as touch of the display or pressure on the display (via touch, 3D touch and change of the texture itself) are possible.

These additional axes can be used for moving a virtual stylus tip or for menu parameters as the illustration with the stylus on the bottom right shows.

The background illumination of the display in case of an OLED display, the display itself or specially installed IR pixels (infrared) can serve for illuminating the object.

The system can be extended with special optical markers (for example QR code—fixedly mounted on the input object, adherable or capable of being displayed by display), to which special characteristics can be assigned. For example an erasing function, a color change. The markers can also be invisible, for example via IR.

The position recognition is effected via the recorded image or else in combination with a touch sensor (pressure, resistive, capacitive, inductive, IR, ultrasound).

The subject matter from DE 10 2011 084 809 A1 uses a method for computer-assisted control of a user interface by means of a high-definition camera, a touchscreen touch by an object or a hand, wherein a barcode on the bottom side of the item is used for control.

In contrast thereto, the present invention uses object features such as for example the fingerprint, the skin condition or the surface structure. Thereby, the system of the present invention is not restricted to special input media.

The present invention relates to a method for controlling a display function of a display apparatus by any input object via a touchscreen. Thereto, a camera apparatus of a recording apparatus creates an image sequence of the user-facing screen surface of the display apparatus. In the images of the image sequence, an input object is tracked by a computing unit of the recording apparatus when the input object is tilted, inclined or rolled away with respect to the screen surface. Thereto, the image sequence is searched for a pattern including a depth profile in the surface structure of the input object by the computing unit and a change of the image values to the contrast, the image definition of the pattern or additionally or alternatively of the visible portion of the surface structure in the image sequence is evaluated. The computing unit determines a motion vector of the input object from the change of the pattern or the portion of the surface structure visible to the camera apparatus for controlling a display function.

Overall, the example shows how a method for recognizing a movement of an input item with respect to a display apparatus via optical features can be provided.

A description has been provided with reference to various examples, but it will be understood that variations and modifications can be effected within the spirit and scope of the claims which may include the phrase “at least one of A, B, and C” as an alternative expression that means one or more of A, B, and C may be used, contrary to the holding in Superguide v. DIRECTV, 358 F3d 870, USPQ2d 1865 (Fed. Cir. 2004). That is the scope of the expression “at least one of A, B, and C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C. In addition, the term “and/or” includes a plurality of combinations of relevant items or any one item among a plurality of relevant items. That is, the scope of the expression or phrase “A and/or B” includes all of the following: (1) the item “A”, (2) the item “B”, and (3) the combination of items “A and B”.

1-10. (canceled)

11. A method for controlling a display function of a display apparatus, comprising:
capturing, by a camera of a recording apparatus, images of an image sequence of a surface structure of an input object in an input region on a user-facing side of a screen surface of the display apparatus, the input region optically captured from the direction of a side of the screen surface facing away from a user through the screen surface;
recognizing, by a computer of the recording apparatus, that a surface structure is in a focus of the display apparatus on the user-facing side of the screen surface;
searching, by the computer, the first image or multiple initial images of the image sequence for a pattern in the surface structure of the input object;
when a pattern of the surface structure of the input object is recognized in the respective images of the image sequence, determining, by the computer, an orientation and/or a position of the pattern of the surface structure of the input object in the input region;
determining, by the computer, a motion vector of the pattern between the respective orientation and position of the surface structure between an image and an image of the image sequence following the image, the determining a motion vector comprising:
tracking, by the computer, when the input object is tilted and/or inclined and/or rolled away in that a change of the pattern in the images of the image sequence arising in tilting and/or inclination and/or rolling is mapped as tilting and/or rolling and/or inclination of the input object in the motion vector; and
controlling, by the computer by the motion vector, the display function of the display apparatus.

12. The method according to claim 11, wherein the pattern is learned in one or more initial images of the image sequence.

13. The method according to claim 11, wherein the determination of the motion vector includes evaluation of a change of a contrast and/or image definition and/or of a scaling of the pattern and/or of a portion of the surface structure of the input object visible for the recording apparatus in the images of the image sequence.

14. The method according to claim 12, wherein the determination of the motion vector includes evaluation of a change of a contrast and/or image definition and/or of a scaling of the pattern and/or of a portion of the surface structure of the input object visible for the recording apparatus in the images of the image sequence.

15. The method according to claim 11, wherein the control of the display function of the display apparatus is effected only after recognizing a stored, authorized pattern of the surface structure of the input object in an image from the image sequence.

16. The method according to claim 12, wherein the control of the display function of the display apparatus is effected only after recognizing a stored, authorized pattern of the surface structure of the input object in an image from the image sequence.

17. The method according to claim 11, wherein at least one display function is each associated with at least one pattern of the input object.

18. The method according to claim 12, wherein at least one display function is each associated with at least one pattern of the input object.

19. The method according to claim 11, wherein the capture of the respective image of the image sequence is effected in combination with a pressure sensor on the screen surface, wherein the pressure sensor measures a pressure of an input by the input object and the capture of the respective image of the image sequence is initiated upon exceeding a threshold value by the pressure or a value of the measured pressure is associated with at least one display function.

20. The method according to claim 12, wherein the capture of the respective image of the image sequence is effected in combination with a pressure sensor on the screen surface, wherein the pressure sensor measures a pressure of an input by the input object and the capture of the respective image of the image sequence is initiated upon exceeding a threshold value by the pressure or a value of the measured pressure is associated with at least one display function.

21. The method according to claim 11, wherein the pattern of the input object includes at least one optical marker including at least one pattern for respectively controlling a display function.

22. The method according to claim 12, wherein the pattern of the input object includes at least one optical marker including at least one pattern for respectively controlling a display function.

23. A recording apparatus comprising:
a camera to capture images of an image sequence of a surface structure of an input object in an input region on a user-facing side of a screen surface of a display apparatus, the input region optically captured from the direction of a side of the screen surface facing away from a user through the screen surface; and
a computer to:
recognize that a surface structure is in a focus of the display apparatus on the user-facing side of the screen surface;
search the first image or multiple initial images of the image sequence for a pattern in the surface structure of the input object;
when a pattern of the surface structure of the input object is recognized in the respective images of the image sequence, determine an orientation and/or a position of the pattern of the surface structure of the input object in the input region;
determine a motion vector of the pattern between the respective orientation and position of the surface structure between an image and an image of the image sequence following the image, the determine a motion vector comprising:
track when the input object is tilted and/or inclined and/or rolled away in that a change of the pattern in the images of the image sequence arising in tilting and/or inclination and/or rolling is mapped as tilting and/or rolling and/or inclination of the input object in the motion vector, and
calculate the motion vector based on image variables changing compared to a reference image and/or to a previous image in the image sequence and based on an evaluation of a change of an image definition, wherein the change of the pattern arising in erecting the finger is determined by the computer by a change of the image variables of the respective images of the visible portion of the surface structure, including the image definition, and the computer determines the motion vector of the input object from the change of the respective image variable or a combination of the image variables of the respective images of the image sequence; and
control by the motion vector, the display function of the display apparatus.

24. A recording apparatus according to claim 23 wherein the pattern is learned in one or more initial images of the image sequence.

25. A recording apparatus according to claim 23 wherein the determination of the motion vector includes evaluation of a change of a contrast and/or image definition and/or of a scaling of the pattern and/or of a portion of the surface structure of the input object visible for the recording apparatus in the images of the image sequence.

26. A recording apparatus according to claim 24 wherein the determination of the motion vector includes evaluation of a change of a contrast and/or image definition and/or of a scaling of the pattern and/or of a portion of the surface structure of the input object visible for the recording apparatus in the images of the image sequence.

27. A recording apparatus according to claim 23, wherein the control of the display function of the display apparatus is effected only after recognizing a stored, authorized pattern of the surface structure of the input object in an image from the image sequence.

28. A display apparatus, which includes a recording apparatus according to claim 23.

29. A motor vehicle including a recording apparatus according to claim 23.

30. A motor vehicle including a display apparatus according to claim 28.

31. The method according to claim 11, wherein the input object comprises a finger.

32. The method according to claim 11, wherein the determining a motion vector further comprising calculating, by the computer, the motion vector based on image variables changing compared to a reference image and/or to a previous image in the image sequence and based on an evaluation of a change of an image definition, wherein the change of the pattern arising in erecting the finger is determined by the computer by a change of the image variables of the respective images of the visible portion of the surface structure, including the image definition, and the computer determines the motion vector of the input object from the change of the respective image variable or a combination of the image variables of the respective images of the image sequence.

33. The recording apparatus according to claim 23, wherein the input object comprises a finger.

34. The recording apparatus according to claim 23, wherein the determine a motion vector further comprising calculate, by the computer, the motion vector based on image variables changing compared to a reference image and/or to a previous image in the image sequence and based on an evaluation of a change of an image definition, wherein the change of the pattern arising in erecting the finger is determined by the computer by a change of the image variables of the respective images of the visible portion of the surface structure, including the image definition, and the computer determines the motion vector of the input object from the change of the respective image variable or a combination of the image variables of the respective images of the image sequence.
